(19) United States
(12) Patent Application Publication
(10) Pub. No.: US 2014/0340944 A1
(43) Pub. Date: Nov. 20, 2014

(54) METHOD PROVIDING SHORT-CIRCUIT PROTECTION AND FLYBACK CONVERTER UTILIZING THE SAME

(71) Applicant: NEOENERGY MICROELECTRONICS, INC., Chupei City (TW)

(72) Inventors: Ren-Huei TZENG, Chupei City (TW); Kuan-Sheng WANG, Chupei City (TW); Wei-Chuan SU, Chupei City (TW)

(73) Assignee: NEOENERGY MICROELECTRONICS, INC., Chupei City (TW)

(21) Appl. No.: 14/264,270

(22) Filed: Apr. 29, 2014

Related U.S. Application Data
(60) Provisional application No. 61/823,001, filed on May 14, 2013.
(60) Provisional application No. 61/824,571, filed on May 17, 2013.

(51) Int. Cl. H02H 7/12

(52) U.S. Cl. CPC H02H 7/1213
USPC 363/21.17

(57) ABSTRACT

A method providing short-circuit protection and a flyback converter utilizing the same wire are disclosed. The a method, adopted by a flyback converter, includes a transformer, including generating a feedback voltage according to an output voltage output from a secondary winding of the transformer; controlling a primary current through a primary winding of the transformer based on the feedback voltage; determining a sense voltage according to the primary current; determining a short circuit based on the sense voltage; setting the primary current according to a short-circuit sense voltage limit when a short circuit occurs; and setting the primary current according to a normal sense voltage limit when a short circuit does not occur.

### CROSS REFERENCE TO RELATED APPLICATIONS

This application claims priority of U.S. Provisional Applications No. 61/824,571, filed on May 17, 2013, and 61/823,001, filed on May 14, 2013, the entireties of which are incorporated by reference herein.

### BACKGROUND OF THE INVENTION

1. Field of the Invention

The present invention relates to power systems, and in particular, to method providing short circuit protection and a flyback converter utilizing the same.

2. Description of the Related Art

Switching mode power supply (SMPS) converters provide superior power conversion efficiency because an output voltage or output current is regulated with switch transistors that are either on or off so that the SMPS converters never operate in the linear region in which both current and voltage are nonzero. Therefore, since either the transistor current or voltage is close to zero, power dissipation is greatly reduced. Due to the high efficiencies, the SMPS converters have been found to be particularly useful in a variety of portable devices (e.g., mobile phones, digital cameras, tablets, digital music players, media players, portable disk drives, handheld game consoles, and other handheld consumer electronic devices). A flyback control with feedback loop is typically implemented into the SMPS converter to provide power regulation.

In a short circuit, the SMPS converter may be damaged due to a large current passing therethrough. However, the maximum current passing therethrough also limits the maximum power that can be delivered by a SMPS converter. Thus the limitation of the transistor current is a trade-off.

### BRIEF SUMMARY OF THE INVENTION

A detailed description is given in the following embodiments with reference to the accompanying drawings.

An embodiment of a method is disclosed, adopted by a flyback converter including a transformer, including generating a feedback voltage according to an output voltage output from a secondary winding of the transformer; controlling a primary current through a primary winding of the transformer based on the feedback voltage; determining a sense voltage according to the primary current; determining a short circuit condition based on the sense voltage; setting the primary current according to a short-circuit sense voltage limit when a short circuit occurs; and setting the primary current according to a normal sense voltage limit when a short circuit does not occur.

An embodiment of a flyback converter is provided, including a transformer, a secondary circuit, a switch transistor, a sense resistor, and a control circuit. The transformer includes a primary winding and a secondary winding, wherein the secondary winding outputs an output voltage. The secondary circuit, coupled to the secondary winding, is configured to generate a feedback voltage according to the output voltage. The switch transistor is configured to control a primary current through the primary winding of the transformer. The sense resistor, coupled to the switch transistor, is configured to generate a sense voltage proportional to the primary current. The control circuit, optically coupled to the secondary circuit, is configured to control the switch transistor based on the feedback voltage, determine a short circuit based on the sense voltage, set the primary current according to a short-circuit sense voltage limit when a short circuit occurs, and set the primary current according to a normal sense voltage limit when a short circuit does not occur

### BRIEF DESCRIPTION OF THE DRAWINGS

The present invention can be more fully understood by reading the subsequent detailed description and examples with references made to the accompanying drawings, wherein:

FIG. 1 is a schematic diagram of a switching mode power supply (SMPS) 1 according to an embodiment of the invention;

FIG. 2 is a waveform illustrating the primary side current under short circuit condition;

FIG. 3 is a waveform illustrating the primary side current under short circuit condition with current limit;

FIG. 4 illustrates that input current voltage can't response to the feedback signal because of sense voltage limit;

FIG. 5A is a waveform under a short circuit condition in the SMPS 1 according to an embodiment of the invention;

FIG. 5B is a waveform under a heavy load condition in in the SMPS 1 according to an embodiment of the invention;

FIG. 6 is a waveform under a light load condition in in the SMPS 1 according to an embodiment of the invention;

FIG. 7 is a circuit schematic of a control circuit 7 in the PWM controller 12 in FIG. 1 according to an embodiment of the invention;

FIG. 8 is a circuit schematic of a control circuit 8 in the PWM controller 12 in FIG. 1 according to another embodiment of the invention;

FIG. 9 is a waveform illustrating a current limit V_{CS}_{_{—}}ₗᵢₘᵢₜ in FIG. 8 according to another embodiment of the invention;

FIG. 10 waveform illustrating another current limit V_{CS}_{_{—}}ₗᵢₘᵢₜ in FIG. 8 according to another embodiment of the invention; and

FIG. 11 is a flowchart of a control method 11 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

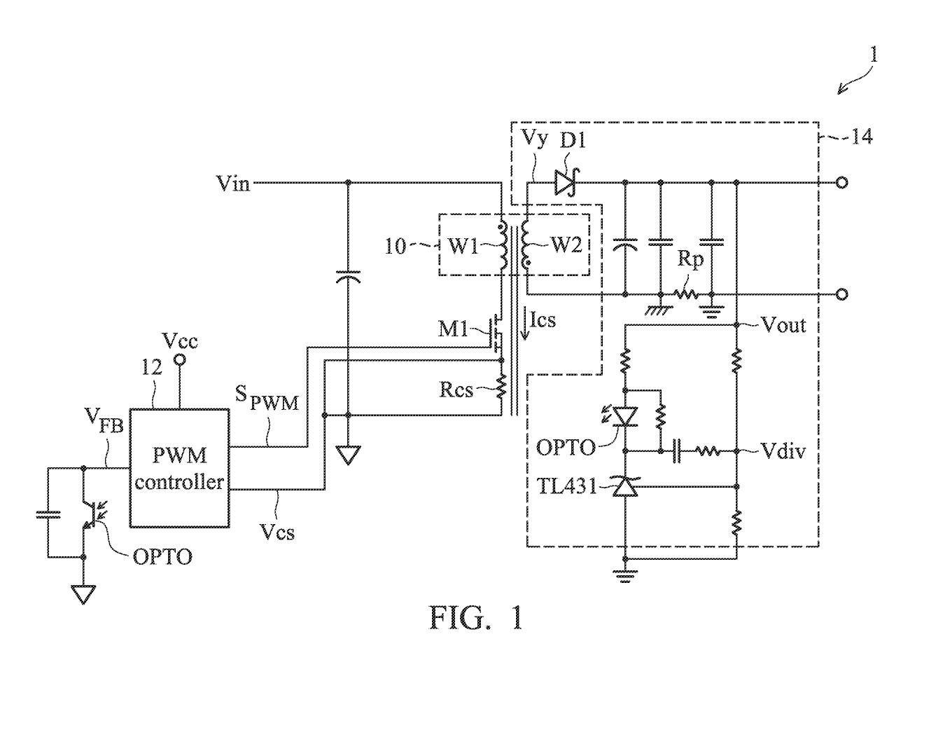

FIG. 1 is a schematic diagram of a flyback switching mode power supply (SMPS) 1 (flyback converter) according to an embodiment of the invention, including a transformer 10, a PWM controller 12 (control circuit), a secondary circuit 14, a switch transistor M1, and a sense resistor Rcs.

The control loop of the flyback SMPS 1 is formed by sensing an output voltage Vout of a secondary winding W2 of the transformer 10 and controlling the primary current Ics by turning the switch transistor M1 on or off. In order to acquire the value of the output voltage at the primary side of the transformer 10, the output voltage Vout is divided into a voltage Vdiv through the secondary circuit 14 which contains a resistor network. The voltage Vdiv controls the shunt regulator TL431 which generates a current proportional to the difference between Vdiv and an internal reference voltage in the shunt regulator TL431, typically at 2.5V. The current generated is converted into a feedback voltage V_{FB} through the optocoupler, OPTO. The PWM controller 12 uses the feedback voltage V_{FB} to generate a control signal KV_{FB} to control the primary current Ics. The primary current Ics is sensed by the sense resistor Rcs to generate a sense voltage Vcs, expressed by Equation [1].

Vcs=Ics*Rcs Equation [1]

As soon as the sense voltage Vcs approaches K*V_{FB}, the PWM controller 12 will turn the switch transistor M1 off and the peak primary current Ics,peak is determined by Equation [2]:

Ics,peak=K*V_{FB}/Rcs Equation [2]

where K is a factor which converts the feedback signal V_{FB} to the control signal KV_{FB}. By this way, the PWM controller 12 can adjust the proper input power for regulating the output voltage Vout to meet the power demand of the output loading (not shown).

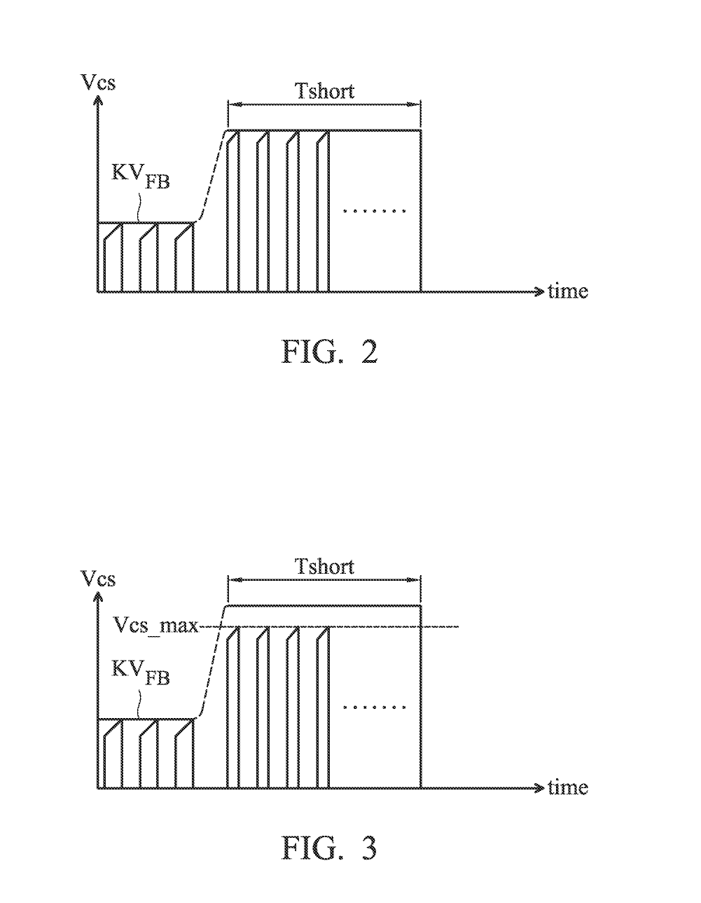

Conventional short-circuit protection is provided by the feedback voltage V_{FB}, as shown by a waveform in FIG. 2. FIG. 2 shows that the sense voltage Vcs is limited by the control signal KV_{FB}. More specifically, the PWM controller 12 compares the feedback voltage V_{FB} with the sense voltage Vcs, and turn off the switch transistor M1 as soon as the sense voltage reach the KV_{FB}. It means that the peak value of the transistor current is determined by the feedback voltage. When a short circuit condition happens, the output voltage Vout is very close to zero and the feedback voltage V_{FB} will be pulled up to a saturate level to demand more input current Ics. If the feedback voltage V_{FB} keeps saturated for longer than a specific delay time Tshort, the PWM controller 12 will shut down the flyback SMPS 1 by turning off the switch transistor M1. During the delay time Tshort, the feedback voltage V_{FB} remains saturated and the switch transistor M1 is subjected to a high operating current. As soon as the switch transistor M1 is cut off, the leakage inductor of the transformer cause a resonant voltage at M1's drain. The resonance voltage is proportional to the peak value of Ics when the switch transistor M1 is turned-off. It means that the high operating current under a short circuit may create more voltage stress on the switch transistor M1.

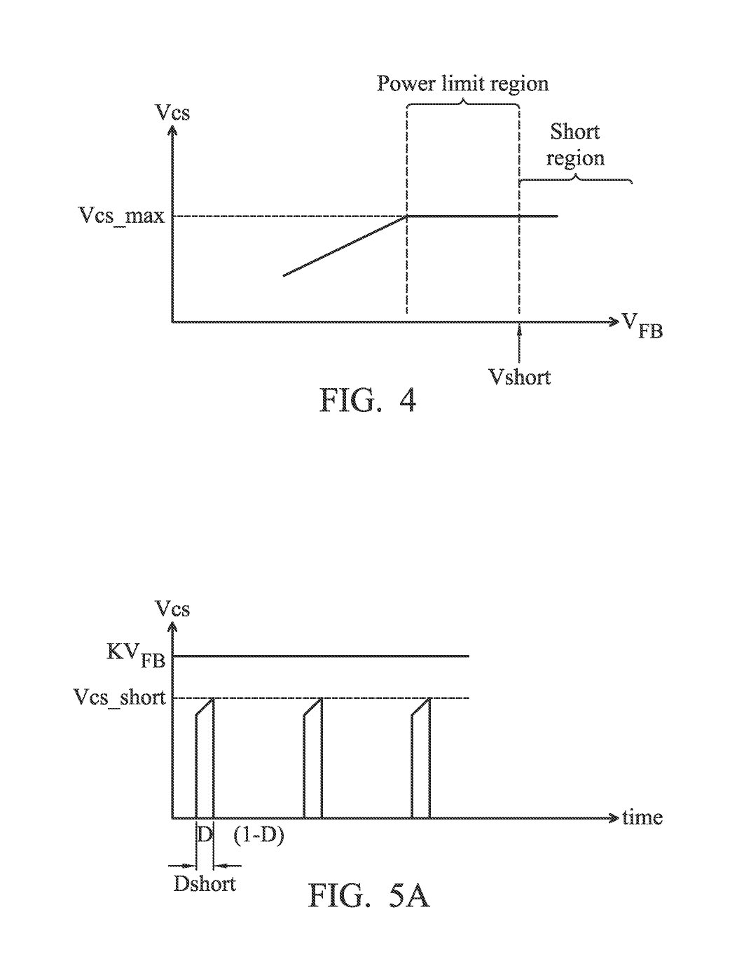

In order to reduce the voltage stress, an extra current limit Vcs_limit lower than the saturate level of KV_{FB} is added to reduce the peak current of MOS M1 under a short circuit condition, as depicted in FIG. 3. However, this current limit Vcs_limit reduces the maximum power since the maximum input current is restricted when the increasing feedback voltage asks for more input power, as shown in FIG. 4.

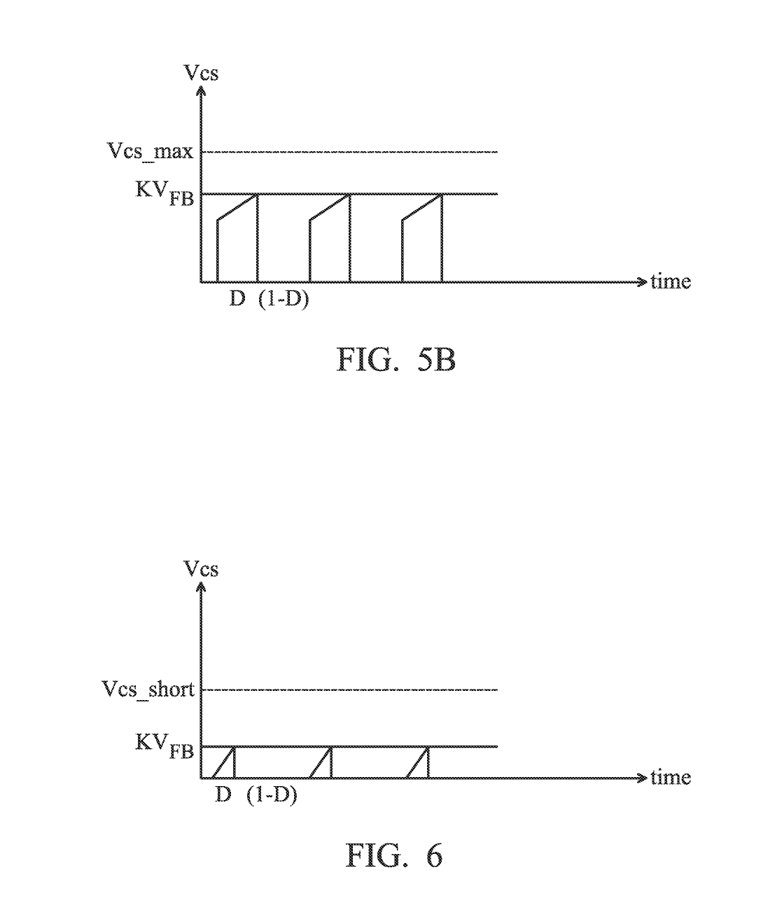

In the embodiments according to the invention, short-circuit protection methods and flyback SMPS utilizing the same are presented in FIGS. 5 through 11. The short-circuit protection method can provide different sense voltage limits Vcs_limit for a normal operation and a short circuit condition, and it can fulfill both maximum power delivering and short circuit MOS stress.

A short-circuit protection method for peak current mode control is disclosed. The detection method is based on the observation of a duty cycle, D, of the PWM signal Spwm output by the PWM controller 12. For the flyback SMPS 1 operates under heavy load or short circuit, the duty cycle D of the PWM signal S_{PWM} and the sense voltage Vcs are determined by the voltage-second balance Equation [3] (ignore the diode voltage drop of the diode D1 in FIG. 1):

Vout/Vin=n*D/(1−D) Equation [3]

where n is a turn ratio of the transformer 10 between the primary and secondary windings.

When a short circuit condition occurs, the output voltage Vout approaches zero. Consequently the duty cycle D decreases to a minimum allowed threshold (predetermined duty threshold). On the contrary, in a heavy load condition with a regulated output voltage Vout, the duty cycle D is much larger than the minimum allowed threshold. By monitoring the duty cycle D, when D is smaller than a preset minimum value, the PWM controller 12 can determine a short circuit state and triggers a protection action.

Turning to FIG. 5A, which illustrates a waveform under a short circuit condition in the SMPS 1 according to an embodiment of the invention.

When a short circuit condition occurs, the output voltage Vout is closed to zero. According to the voltage-second balance equation [3], the duty cycle D of the flyback SMPS 1 is small. As a result, we can set a limit Dshort (predetermined duty threshold) to trigger a smaller short-circuit sense voltage limit Vcs_short as new Vcs limit when the duty cycle D is smaller than the Dshort, as shown in FIG. 5A. As explained previously, by lowering the sense voltage Vcs, the voltage stress across M1 is reduced. The heavy load and short circuit conditions can be distinguished by the duty cycle D of the sense voltage Vcs, which is the same as the on duty cycle of switch transistor M1. The duty cycle D under a short circuit condition is Dₛₕₒᵣₜ and is smaller than a duty cycle under a heavy load condition, which is shown in FIG. 5B. Since the output voltage Vout is still regulated by the target voltage KV_{FB} under the heavy load, the limitation of Dshort could be calculated by the following expression [4] with the target Vout:

D=Vout/(Vout+n*Vin)>Dshort Expression [4]

FIG. 6 is a waveform under a light load condition in the SMPS 1 according to an embodiment of the invention. In FIG. 6, we can notice that the duty cycle D is also reduced in light load conditions and it may be smaller than the short circuit limit Dshort. But this condition can be distinguished from the short circuit condition because during a light load switching, the peak current is limited by a KV_{FB} which is much smaller than the short-circuit sense voltage limit Vcs_short. It means that the short circuit protection does not function and the system is still under the close loop peak current control formed by V_{FB}.

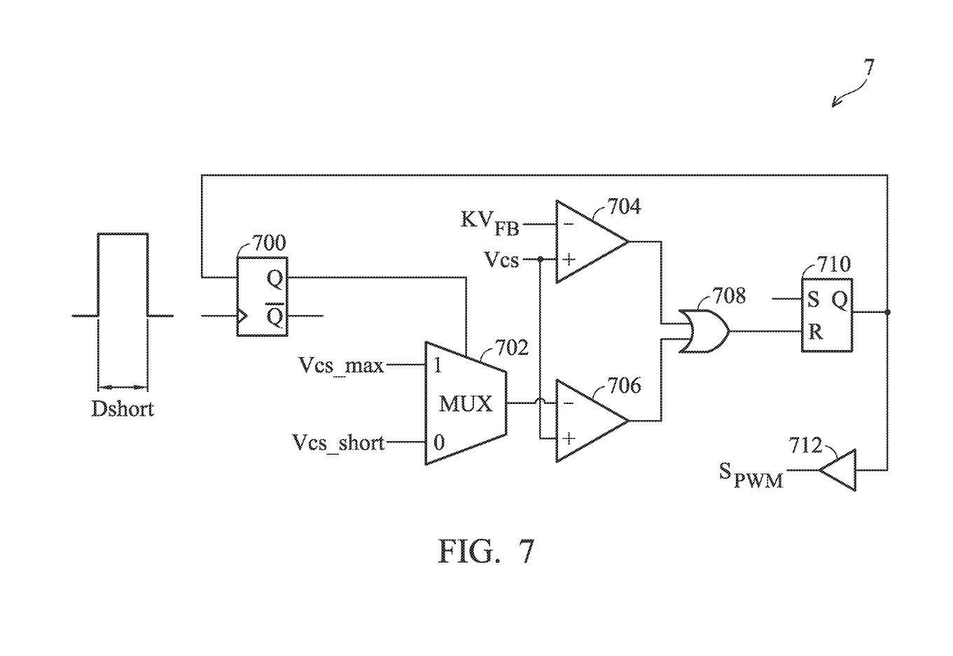

FIG. 7 is a circuit schematic of the PWM controller 12 in FIG. 1 according to an embodiment of the invention. With this circuit, the PWM controller 12 can adjust the Vcs_limit of next switching cycle according to that if the duty cycle D of the sense voltage Vcs is larger than Dshort or not. The circuit 7 contains a flip-flop 700, a multiplexer 702, comparators 704 and 706, an OR gate 708, a flip-flop 710 and a buffer 712.

The flip-flop 700 receives the sense voltage Vcs and is clocked by a signal a short-circuit duty cycle Dshort. When the sense voltage Vcs has a duty cycle D less than the short-circuit duty cycle Dshort, the flip-flop 700 outputs a selection signal to the multiplexer 702 to select the short-circuit sense voltage limit Vcs_short. When the sense voltage Vcs has a duty cycle D exceeds the short-circuit duty cycle Dshort, the flip-flop 700 outputs the selection signal to the multiplexer 702 to select the normal sense voltage limit Vcs_max. The comparator 706 compares the sense voltage Vcs against one of the short-circuit sense voltage limit Vcs_short and the normal sense voltage limit Vcs_max, depending on the duty cycle D. In the embodiments, the comparator 706 compares the sense voltage Vcs against the short-circuit sense voltage limit Vcs_short in the short circuit and light load conditions, and compares against the normal sense voltage limit Vcs_max in the heavy load condition. The comparator 704 compares the sense voltage with the control signal KV_{FB}. The OR gate 708 determines whether the sense voltage Vcs exceeds the control signal KV_{FB}, or the selected sense voltage limit. When it is so, the buffer 712 is configured to output the PWM signal S_{PWM} to turn off the switch transistor M1.

With reference to FIG. 5A and FIG. 7, in the short circuit condition, the comparator 706 compares the sense voltage Vcs with the short-circuit sense voltage limit Vcs_short and the comparator 704 compares the sense voltage with the control signal KV_{FB}, because the short-circuit sense voltage limit Vcs_short is less than the control signal KV_{FB}, the comparator 706 will indicate the sense voltage Vcs has reached the short-circuit sense voltage limit Vcs_short before the comparator 704 does. As a result, the buffer 712 will output PWM signal S_{PWM} to turn off the switch transistor M1 upon the sense voltage Vcs reaches the short-circuit sense voltage limit Vcs_short.

With reference to FIG. 5B and FIG. 7, in the heavy load condition, the comparator 706 compares the sense voltage Vcs with the normal sense voltage limit Vcs_max and the comparator 704 compares the sense voltage with the control signal KV_{FB}. Because the control signal KV_{FB} is less than the normal sense voltage limit Vcs_max, the comparator 704 will indicate the sense voltage Vcs has reached the control signal KV_{FB} until the sense voltage Vcs reaches the normal sense voltage limit Vcs_max. The buffer 712 will output PWM signal S_{PWM} to turn off the switch transistor M1 upon the sense voltage Vcs has reached the control signal KV_{FB} or the normal sense voltage limit Vcs_max.

With reference to FIG. 6 and FIG. 7, in the light load condition, the comparator 706 compares the sense voltage Vcs with the short-circuit sense voltage limit Vcs_short and the comparator 704 compares the sense voltage with the control signal KV_{FB}. Since the control signal KV_{FB} is always less than the short-circuit sense voltage limit Vcs_short, the comparator 704 will indicate the sense voltage Vcs has reached the control signal KV_{FB} before reaching the short-circuit sense voltage limit Vcs_short. The buffer 712 will output PWM signal S_{PWM} to turn off the switch transistor M1 upon the sense voltage Vcs has reached the control signal KV_{FB}.

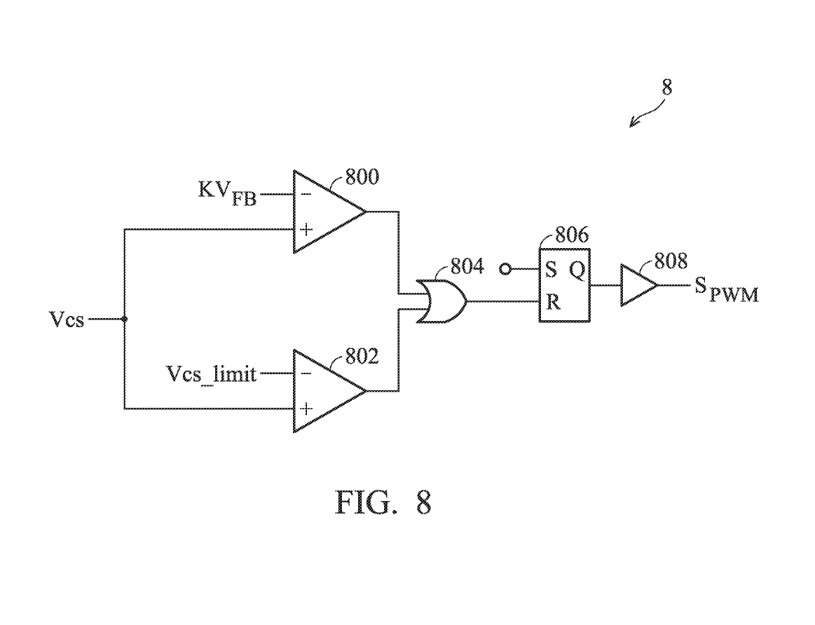

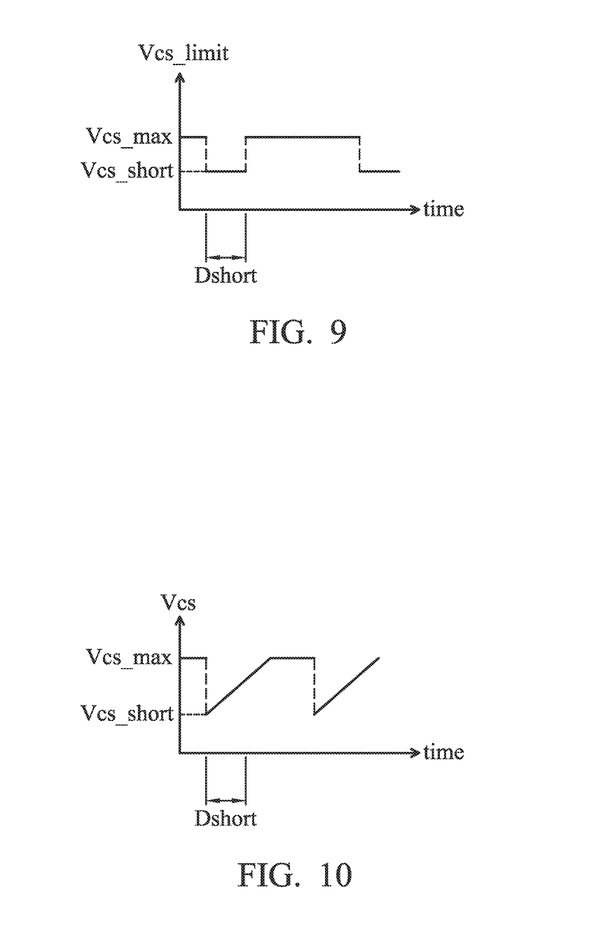

Another implementation is to provide a variant sense voltage limit Vcs_limit, which has a smaller short-circuit sense voltage limit Vcs_short during the short-circuit duty threshold Dshort and a normal sense voltage limit Vcs_max after the short-circuit duty threshold Dshort. The circuit implementation is shown in FIG. 8 and the waveform of the sense voltage limit Vcs_limit is shown in FIG. 9.

FIG. 8 is a circuit schematic of a control circuit 8 in the PWM controller 12 in FIG. 1 according to another embodiment of the invention. The control circuit 8 contains comparators 800 and 802, an OR gate 804, a flip-flop 806 and a buffer 808.

Accordingly, the sense voltage limit Vcs_limit is set to be the short-circuit sense voltage limit Vcs_short when the on-time of the sense voltage Vcs is less than the short-circuit duty threshold Dshort, and set to be the normal sense voltage limit Vcs_max when the on-time of the sense voltage Vcs exceeds the short-circuit duty threshold Dshort. Thus, when the on-time is less than the short-circuit duty threshold Dshort, the comparator 802 compares the sense voltage Vcs against the short-circuit sense voltage limit Vcs_short. When the on-time exceeds the short-circuit duty threshold Dshort, the comparator 802 compares the sense voltage Vcs against the normal sense voltage limit Vcs_max. Concurrently, the comparator 800 compares the sense voltage Vcs against the control signal KV_{FB}. The OR gate 804 determines whether the sense voltage Vcs exceeds the control signal KV_{FB}, or the sense voltage limit Vcs_limit. When it is so, the buffer 808 is configured to output the PWM signal S_{PWM} to turn off the switch transistor M1, otherwise, the switch transistor M1 remains on.

Turning to FIG. 9, illustrating the sense voltage limit Vcs_limit is set by the short-circuit duty threshold Dshort and the normal sense voltage limit Vcs_max. If the duty cycle D of the sense voltage Vcs falls below the short-circuit duty threshold Dshort, the current peak will limited by the short-circuit sense voltage limit Vcs_short. The duty cycle under heavy load will be larger than the short-circuit duty threshold Dshort and the limitation will change to the normal sense voltage limit Vcs_max, which is large enough for maximum power delivery.

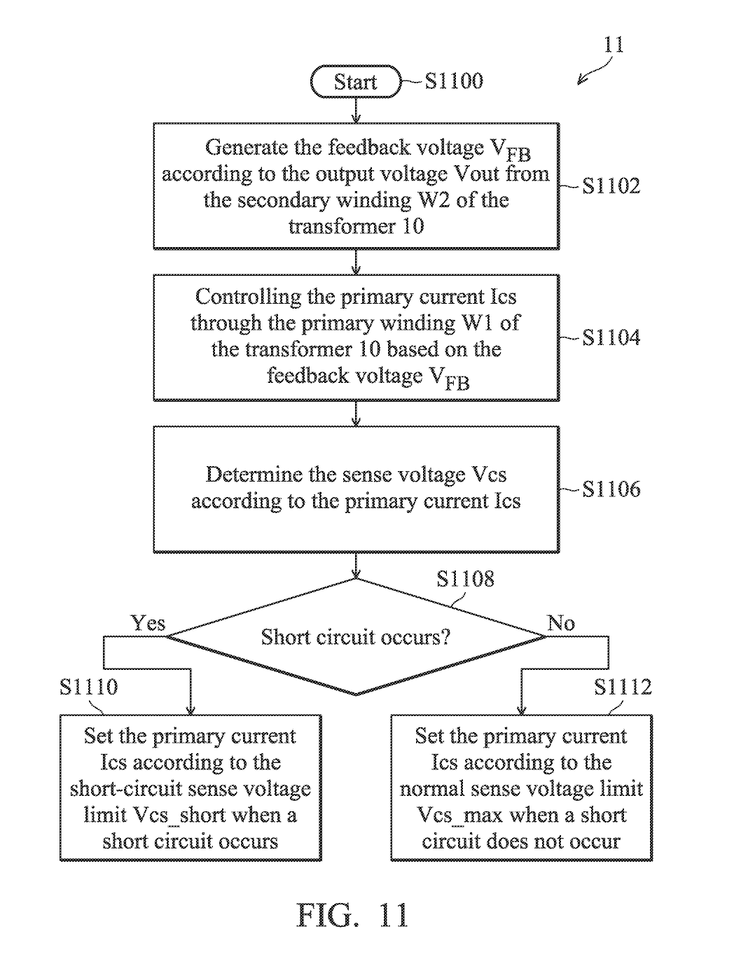

In the dynamic Vcs_limit implementation, the sense voltage limit Vcs_limit does only have to smaller than the saturated KV_{FB} during the short-circuit duty threshold Dshort, and it does not have to be a constant. A continuous waveform of Vcs_limit can be an example as shown in FIG. 10.

FIG. 11 is a flowchart of a control method 11 according to an embodiment of the invention, incorporating the flyback SMPS 1 in FIG. 1. In addition, the control method 11 is adopted by the control circuits 7 or 8 in FIGS. 7 and 8.

Upon startup, the flyback SMPS 1 is powered on to supply power to a connected load (S1100). The connected load may be a heavy load, a light load, or short-circuited. Next, the secondary circuit 14 is configured to generate the feedback voltage V_{FB} according to the output voltage Vout from the secondary winding W2 of the transformer 10 (S1102). Specifically, the resistor network in the secondary circuit 14 divides the output voltage Vout into the divided voltage Vdiv, the difference of the divided voltage Vdiv and a reference signal is then converted by the shunt regulator TL431 into a current, which is converted into the feedback voltage V_{FB} through the optocoupler OPTO.

The PWM controller 12 receives the feedback voltage V_{FB} from the optocoupler OPTO and controls the primary current Ics based on the feedback voltage V_{FB} (S1104). The PWM controller 12 is also configured to monitor the sense voltage which is the primary current Ics flows across the sense resistor Rcs (S1106). In operation, the PWM controller 12 generates the internal control signal KV_{FB}, and compares the sense voltage Vcs against the internal control signal KV_{FB} to produce the PWM signal S_{PWM}, which is used to turn the switch transistor M1 on or off, thereby controlling the value of the primary current Ics.

The PWM controller 12 can determine the current limitation under short circuit condition or normal operation. In some embodiments, the PWM controller 12 determines a short circuit condition based on the duty cycle, as detailed in the embodiments of FIGS. 5A, 5B through 7. In other embodiments, the PWM controller 12 telling normal operation and short circuit limit bases on the on-time of the sense voltage Vcs, as detailed in the embodiments of FIGS. 8 through 10.

When a short circuit condition has occurred, the PWM controller 12 is configured to set the primary current Ics according to the short-circuit sense voltage limit Vcs_short (S1110). Otherwise, the PWM controller 12 is configured to set the primary current Ics according to the normal sense voltage limit Vcs_max (S1112). The short-circuit sense voltage limit Vcs_short is less than the normal sense voltage limit Vcs_max. In the short circuit condition, the PWM controller 12 further outputs the PWM signal S_{PWM} to turn off the switch transistor M1 when the sense voltage Vcs exceeds the short-circuit sense voltage limit Vcs_short. Whereas in the non-short circuit condition, in particularly the heavy load condition, the PWM controller 12 further outputs the PWM signal S_{PWM} to turn off the switch transistor M1 when the sense voltage Vcs exceeds the normal sense voltage limit Vcs_max. By incorporating different sense voltage limits for the sense voltage Vcs in the short circuit condition and the non-short circuit condition, the control method 11 reduces voltage stress across the switch transistor M1 in the short circuit condition, while providing maximum power delivery in the normal operation.

When the PWM controller 12 determines a short circuit condition based on the duty cycle of the sense voltage Vcs, it determines the duty cycle D of the sense voltage Vcs, determines a short circuit condition when the duty cycle D is less than the predetermined duty threshold Dshort, and determines a short circuit condition has not occurred when the duty cycle D exceeds the predetermined duty threshold Dshort.

When the PWM controller 12 determines a variant sense voltage limit for short condition and normal operation, it determines the duty threshold Dshort, determines a smaller sense voltage limit Vcs_short during the predetermined duty threshold Dshort, and determines a normal sense voltage limit Vcs_max when exceeds the predetermined duty threshold Dshort.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general-purpose processor, a digital signal processor (DSP), an application-specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The operations and functions of the various logical blocks, units, modules, circuits and systems described herein may be implemented by way of, but not limited to, hardware, firmware, software, software in execution, and combinations thereof.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method, adopted by a flyback converter including a transformer, comprising:
generating a feedback voltage according to an output voltage output from a secondary winding of the transformer;
controlling a primary current through a primary winding of the transformer based on the feedback voltage;
determining a sense voltage according to the primary current;
determining a short circuit based on the sense voltage;
setting the primary current according to a short-circuit sense voltage limit when a short circuit occurs; and
setting the primary current according to a normal sense voltage limit when a short circuit does not occur.

2. The method of claim 1, wherein the step of determining the short circuit comprises:
determining a duty cycle of the sense voltage; and
determining the short circuit when the duty cycle is less than a predetermined duty threshold.

3. The method of claim 1, wherein the step of determining the short circuit comprises:
determining a two-segment sense voltage limit;
determining the short-circuit sense voltage limit as a first segment of the two-segment sense voltage limit, when an on-time of the sense voltage is less than a predetermined duty threshold.

4. The method of claim 3, wherein the step of determining the short circuit comprises:
determining the normal sense voltage limit as a second segment of the two-segment sense voltage limit, when an on-time of the sense voltage exceeds the predetermined duty threshold.

5. The method of claim 1, wherein the short-circuit sense voltage limit is less than the normal sense voltage limit.

6. The method of claim 1, wherein the step of setting the primary current according to the short-circuit sense voltage limit comprises:
when the sense voltage exceeds the short-circuit sense voltage limit, turning off a switch transistor, which is coupled to the primary winding of the transformer, and generates the primary current.

7. A flyback converter, comprising:
a transformer, comprising a primary winding and a secondary winding, wherein the secondary winding outputs an output voltage;
a secondary circuit, coupled to the secondary winding, generating a feedback voltage according to the output voltage;
a switch transistor, controlling a primary current through the primary winding of the transformer;
a sense resistor, coupled to the switch transistor, establishing a sense voltage by the primary current; and
a control circuit, optically coupled to the secondary circuit, configured to control the switch transistor based on the feedback voltage, determine a short circuit based on the sense voltage, set the primary current according to a short-circuit sense voltage limit when a short circuit occurs, and set the primary current according to a normal sense voltage limit when a short circuit does not occur.

8. The flyback converter of claim 7, wherein:
the control circuit is configured to determine a duty cycle of the sense voltage, and determine the short circuit when the duty cycle is less than a predetermined duty threshold;
and the control circuit further comprises a multiplexer, configured to select one of the short-circuit sense voltage limit and the normal sense voltage limit according to whether the short circuit is determined.

9. The flyback converter of claim 7, wherein the control circuit is configured to determine an on-time of the switch transistor by the sense voltage; and determine the short circuit when the on-time is less than a predetermined duty threshold.

10. The flyback converter of claim 9, wherein the control circuit is configured to determine the short circuit does not occur when the on-time exceeds the predetermined duty threshold.

11. The flyback converter of claim 9, wherein the control circuit comprises a comparator, configured to compare the sense voltage with the short-circuit sense voltage limit when the on-time is less than the predetermined duty threshold to output a pulse width modulation (PWM) signal, and compare the sense voltage with the normal sense voltage limit when the on-time exceeds the predetermined duty threshold to output the PWM signal; and
the control circuit is configured to control the switch transistor by the PWM signal.

12. The flyback converter of claim 7, wherein the short-circuit sense voltage limit is less than the normal sense voltage limit.

13. The flyback converter of claim 7, wherein when the sense voltage exceeds the short-circuit sense voltage limit, the control circuit is configured to shut the switch transistor to turn off the primary current.
